(19) United States
(12) Patent Application Publication
(10) Pub. No.: US 2026/0008942 A1
(43) Pub. Date: Jan. 8, 2026

(54) SYSTEMS FOR REUSABLE HIGH-STRENGTH ADHESIVE MOUNTS

(71) Applicant: SWISSCOM AG, Bern (CH)

(72) Inventor: Reto Straumann, Bern (CH)

(21) Appl. No.: 19/326,151

(22) Filed: Sep. 11, 2025

(30) Foreign Application Priority Data
Feb. 19, 2016 (CH) 00223/16

(51) Int. Cl. C09J 7/30; F16M 13/02

(52) U.S. Cl. CPC C09J 7/30; F16M 13/02

(57) ABSTRACT

Systems are provided for reusable high-strength adhesive mounts. An example system for reusable high-strength adhesive mounts may include a flexible modified gecko tape and a non-flexible second bonding side. The gecko tape may include a nanostructured side and a non-structured side, with the non-structured side including a plurality of attachment structures. The non-flexible second bonding side may include a plurality of attachment counterparts enabled to mechanically couple to the attachment structures. The mechanical coupling may be operable to couple and decouple multiple times. The mechanical coupling of the flexible modified gecko tape with the non-flexible second bonding side may create a torsion-resistant assembly.

### CROSS-REFERENCE TO RELATED APPLICATIONS/INCORPORATION BY REFERENCE

None.

### FIELD OF THE INVENTION

Certain embodiments of the invention relate to adhesive mounting systems. More specifically, certain embodiments of the invention relate to a system for reusable high-strength adhesive mounts.

### BACKGROUND OF THE INVENTION

Adhesive methods and systems are well known and typically involve some form of adhesive material that is used to bind two object together and resist their separation. Typical examples are various forms of glue, reactive or non-reactive, that generally involve some form of high-viscosity liquid or paste that is used between the binding surfaces and may or may not harden. One disadvantage of glues is that they are often not intended to be reusable in the sense that they do not allow frequent and/or easy separation and re-binding of the bonded surfaces. In general, the higher the bonding strength of a glue, the more difficult repeated separation and bonding becomes. For example, while “sticky notes” are reusable a few times, their bonding strength is weak and they are susceptible to contamination through dust and other particles that lower their adhesive strength further upon reapplication. On the other hand, many glues allow very strong bonding but harden out and effectively do not allow easy separation and may even risk breaking the bonding surfaces and/or the attached objects. These high-strength adhesives are thus essentially intended for a single use. Another disadvantage of glues is that they often cannot be removed very well and leave a residue, often gooey, on the bonding surfaces. This in turn can be unsightly and reduce the adhesive strength on rebonding.

Recent years have seen large advancements in the field of reusable adhesives. Particularly noteworthy have been advances in the development of synthetic setae (elastic hair) modelled after the toes and feet of the gecko. The gecko's toes are covered in setae that split into nanoscale structures which can exploit what is known as van der Waals forces to create adhesive strength. These structures allow the creation of high-strength bonds and are inherently robust against contamination, e.g. through dust. Furthermore, like gecko feet, these structures are not sticky to the touch and leave no residue when removed since the adhesion is based on intermolecular forces and the overall adhesive force is due to the sheer number of nano-scale contact points.

Such synthetic adhesives are sometimes referred to as gecko tape. Gecko tape typically is made of some flexible material like polymers or carbon nanotubes that allow the nanostructures to be manufactured and have the required flexibility and strength. For example, gecko tape may be conventionally glued onto a device (on the side without the gecko nanostructure) and the device may then be attached to a typically smooth surface. Since the gecko nanostructure can be removed and reattached many times, this allow to create a high-strength adhesive bond ideally suited for reuse. One of the problems, however, is the sheer amount of adhesive force can make it difficult to remove larger adhesive surfaces comprising a gecko nanostructure.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for reusable high-strength adhesive mounts, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a cross-section of an exemplary device mounting using gecko nanostructures (prior art).

FIG. 2 shows a modified gecko tape, in accordance with various embodiments of the invention.

FIG. 3 shows an exemplary cross-section of an attachment structure 14, in accordance with various embodiments of the invention.

FIG. 4 shows an exemplary cross-section of an attachment structure 14, in accordance with various embodiments of the invention.

FIG. 5A shows an exemplary modified gecko tape with an attachment structure, in accordance with various embodiments of the invention.

FIG. 5B shows an exemplary cross-section of a modified gecko tape using a rail attachment structure in accordance with FIG. 5A.

### DETAILED DESCRIPTION OF THE INVENTION

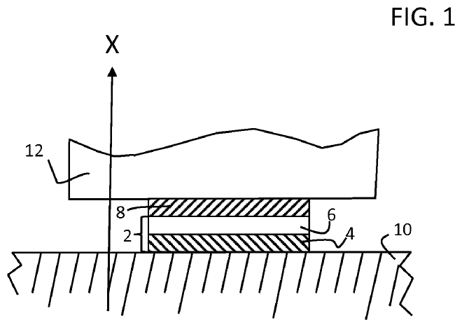

Certain embodiments of the invention may be found in a method and system for reusable high-strength adhesive mounts. Aspects of the method are provided, substantially as shown and described with respect to at least one of FIGS. 1-5B, for reusable high-strength adhesive mounts.

FIG. 1 is a cross-section of an exemplary device mounting using gecko nanostructures (not to scale). Referring to FIG. 1, there is shown a cross-section of a gecko tape 2, an adhesive bond 8, a first bonding surface 10, and a second bonding surface 12. There is also shown a direction X, substantially perpendicular to the first bonding surface 10. The gecko tape 2 may comprise a nanostructures side 4 and a non-structured side 6. The gecko tape 2 may be a sheet-or film-like material in that it's cross-section shown is generally of a much smaller dimension (thickness) than its two other dimensions. Often, the gecko tape 2 may take the shape of a round or rectangular patch but it is understood to the person skilled in the art that the tape may be any shape. The gecko tape 2 may be manufactured from a flexible material, for example a polymer, but other materials may be used. The material used for manufacturing the gecko tape 2 is in part determined by the ability to create the required nanostructures and the corresponding adhesive properties on the nanostructures side 4 of the gecko tape 2. The nanostructured side 4 may comprise nanostructures that enable the nanostructured side 4 to adhesively fasten to a first bonding surface 10, using the van der Waals intermolecular forces. The nanostructured side 4 may be covered partly or entirely in a corresponding nanostructure. The non-structured side 6 of the gecko tape 2 is typically smooth but does not contain any gecko nanostructure.

The first bonding surface 10 may be substantially smooth, although this may not be required, depending on the specific structure of the nanostructure side 4. In accordance with various embodiments of the invention, the first bonding surface 10 may, for example, be a glass surface, plastic surface, metallic surface etc. The second bonding surface 2 may be a device or other object that one may desire to attach and detach to and from the first bonding surface 10 repeatedly. The adhesive bond 8 may such that it enables attaching of the gecko tape 2 to the second bonding surface 12. The adhesive bond 8 may be formed using conventional glue or any other suitable form of adhesive. With the gecko tape 2 securely attached/fixed to an object comprising the second bonding surface 12, the object may be attached to a first bonding surface 10 such that the nanostructured side 4 of the gecko tape 2 forms an adhesive bond with the first bonding surface 10.

The strength of the adhesive bond formed between the nanostructured side 4 and the first bonding surface is a function of the specific properties of both the nanostructured side 4 and the first bonding surface 10, as well as the contact surface between the gecko tape 2 (on the nanostructured side 4) and the first bonding surface 10. In general, the larger the contact surface between the gecko tape 2 and the first bonding surface, the stronger the adhesive bond thus formed. Generally, the adhesive bond formed by between the gecko tape 2 and the first bonding surface is strongest approximately in direction X, i.e. substantially perpendicular to the first bonding surface 10.

Generally, the contact surface area between the gecko tape 2 and the first bonding surface 10 is comparatively small (e.g. some square-centimeters) because it may otherwise be difficult to break the adhesive bond manually and without excessive force, which may lead to damage of the first bonding surface 10, or the object comprising the second bonding surface 12. However, by limiting the surface of the contact area between the nanostructured side 4 and the first bonding surface 10, the supported force by the bond is also limited and thus a compromise between the strength/force that the adhesive bond may need to support and the ease of detachability must be found. While the strength of the adhesive bond between the nanostructured side 4 and the first bonding surface may be strongest in the direction X, even the forces in a direction perpendicular to X, essentially in parallel to the first bonding surface 10 may be considerable.

It was found, however, that if the gecko tape 2 is indeed made of a flexible material such as a polymers etc., even larger area gecko tapes may be easily removed by essentially “peeling” them off the first bonding surface 10, similar to the action of peeling off an adhesive tape, plaster etc. Peeling off, however, is not feasible if the gecko tape 2 is fixed securely to the second bonding surface 12 of an object or device. It is, thus, an object of the current invention to propose suitable, detachable mounts between the second bonding surface 12 and a gecko tape 2, such that a larger area gecko tape may be more easily removed by peeling it off, while allowing a large contact area between the first bonding surface 10 and the nanostructured side 4 of the gecko tape 2, to allow very strong adhesive bonds when mounted. It is understood by a person skilled in the art that the gecko tape 2 may be using the nanostructures described here, or some other form of dry adhesive with substantially similar properties regarding the application and removal. Thus, it may be advantageous to replace the adhesive bond 8 with some detachable mounting means.

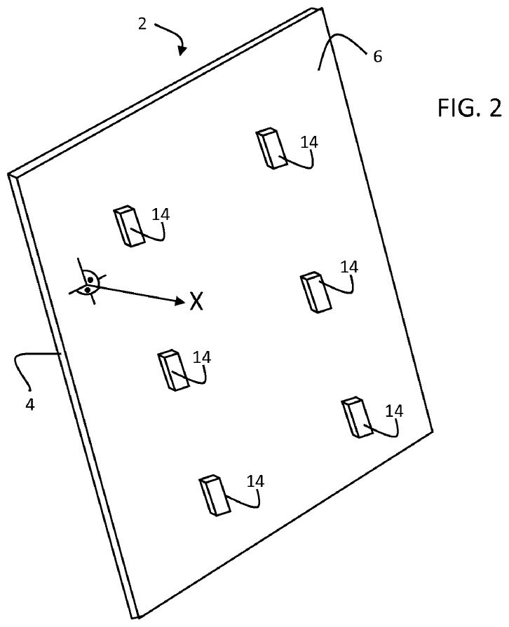

FIG. 2 shows a modified gecko tape, in accordance with various embodiments of the invention. Referring to FIG. 2, there is shown a modified gecko tape 2 comprising a nanostructured side 4 and a non-structured side 6. There are also shown a plurality of (symbolized) attachment structures 14 and a direction X, substantially perpendicular to the non-structured side 6, which is itself substantially parallel to the nanostructured side 4. Elements 4, 6, and direction X may be essentially similar to those described in FIG. 1. The attachment structures 14 may be structural elements placed and/or formed on the non-structured side 6 of the modified gecko tape 2, enabled to allow attachment and detachment to an object, device or second bonding surface 12 via a plurality of attachment counterparts (not shown in FIG. 2) mounted on the object, device or second bonding surface 12, whereby the attachment counterparts are enabled to attach and detach to the attachment structures 14. The attachment structures 14 may be hooks, knobs or any other suitable structure that may mechanically couple with the attachment counterparts. As will be clear to the person skilled in the art, it is equally possible that the attachment structures 14 are on some flexible carrier, e.g. a sheet of polymers, separate from a gecko tape 2, such that a gecko tape 2 is then adhesively bonded in a traditional manner onto the flexible carrier with the attachment structures 14 to form the modified gecko tape 2. This may be advantageous, depending on the manufacturing process of the (modified) gecko tape 2.

Referring to FIG. 2, attaching the modified gecko tape 2 via a plurality of attachment structures 14 to an essentially non-flexible, essentially planar object, device, or second bonding surface 12 with suitable and matched attachment counterparts, the modified gecko tape is mechanically inhibited from flexing in the directions perpendicular to direction X, as shown in FIG. 2. In general, the more attachment structures 14 and corresponding attachment counterparts, the more torsion resistant (also, resistant to bending) the modified gecko tape 2 (and the flexible carrier, if used) becomes, due to the mechanical torsion resistance of the object, device or second bonding surface 12. The effect is thus essentially one of mechanically stiffening the modified gecko tape 2.

Accordingly, it is possible to adhesively attach the modified gecko tape 2 to a first bonding surface 10, for example glass, with the nanostructured side 4. The modified gecko tape 2 can be attached and detached until a suitable position has been found or until the device needs to be (re)moved. For this, the modified gecko tape 2 may simply be peeled off the first bonding surface. Once in a desirable position, the (essentially non-flexible) object, device, or second bonding surface 12 may be attached to the modified gecko tape 2 via the attachment structures 14 and the corresponding attachment counterparts, thereby inhibiting the gecko tape from torsion. Since the gecko tape can then no longer be peeled off, the adhesive bond between the modified gecko tape 2 and the first bonding surface 10 is very strong.

To remove the object, device or second bonding surface 12, the attachment counterparts are detached from the attachment structures 14, thereby allowing the modified gecko tape 2 to flex. Accordingly, the modified gecko tape 2 may then be simply peeled of the first bonding surface 10 again.

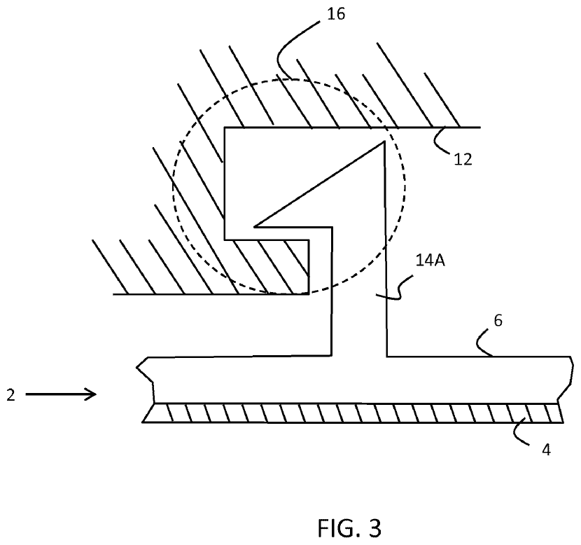

FIG. 3 shows an exemplary cross-section of an attachment structure 14, in accordance with various embodiments of the invention. Referring to FIG. 3, there is shown a modified gecko tape 2 comprising a nanostructured side 4 and a non-structured side 6, and a second bonding surface 12. There is also shown an attachment structure 14 in the shape of a hook 14A. Elements 2, 4, and 6 are essentially identical to those elements in FIG. 1, 2. The attachment element 14 may take the exemplary form of a hook 14A. The hook 14A may be enabled to mechanically couple with the second bonding surface 12. To this end, in accordance with various embodiments of the invention, the hook 14A may be somewhat flexible and the second bonding surface 12 may comprise exemplary attachment counterparts 16 that enable the second bonding surface 12 to be mechanically coupled to the modified gecko tape 2.

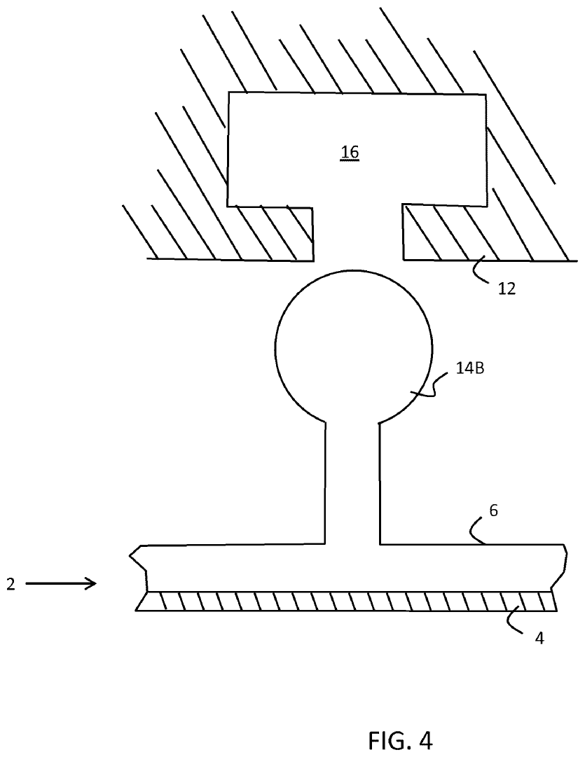

FIG. 4 shows an exemplary cross-section of an attachment structure 14, in accordance with various embodiments of the invention. Referring to FIG. 4, there is shown a modified gecko tape 2 comprising a nanostructured side 4 and a non-structured side 6, and a second bonding surface 12. There is also shown an attachment structure 14 in the shape of a knob 14B. Elements 2, 4, and 6 are essentially identical to those elements in FIG. 1, 2. The attachment element 14 may take the exemplary form of a knob 14B. The knob 14B may be enabled to mechanically couple with the second bonding surface 12. To this end, in accordance with various embodiments of the invention, the knob 14B may be somewhat flexible/compressible and the second bonding surface 12 may comprise exemplary attachment counterparts 16 that enable the second bonding surface 12 to be mechanically coupled to the modified gecko tape 2. In this embodiment, the attachment counterpart 16 may be a recess, for example as illustrated.

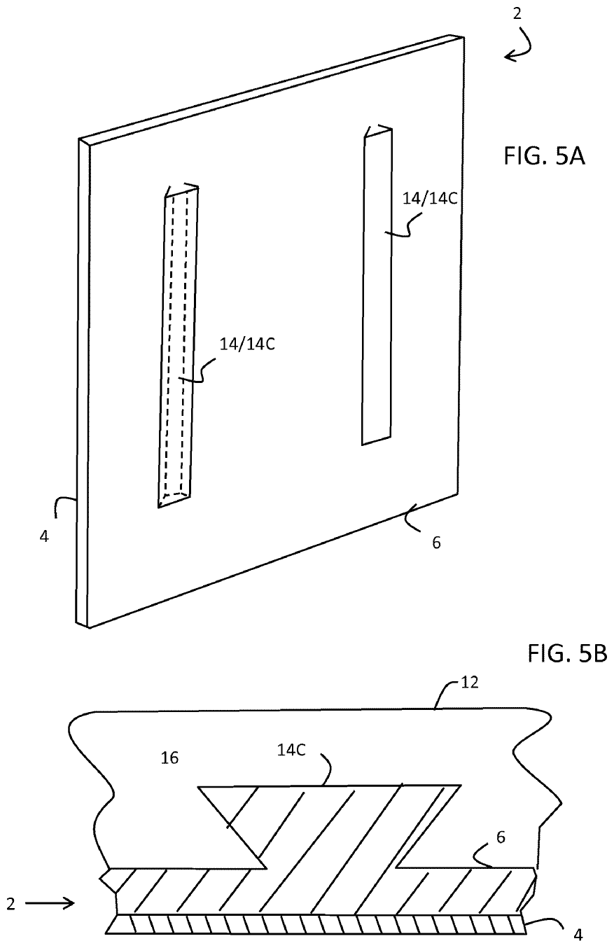

FIG. 5A shows an exemplary modified gecko tape with an attachment structure, in accordance with various embodiments of the invention. Referring to FIG. 5A, there is shown a modified gecko tape 2 comprising a nanostructured side 4 and a non-structured side 6. There is also shown an attachment structure 14 in the shape of a rail 14C. Elements 2, 4, and 6 are essentially identical to those elements in FIGS. 1, 2, 3, and 4. The attachment element 14 may take the exemplary form of a rail 14C.

FIG. 5B shows an exemplary cross-section of a modified gecko tape using a rail attachment structure in accordance with FIG. 5A. Referring to FIG. 5B, there is shown a modified gecko tape 2 comprising a nanostructured side 4 and a non-structured side 6, and a second bonding surface 12. There is also shown an attachment structure 14 in the shape of a rail 14C. Elements 2, 4, and 6 are essentially identical to those elements in FIG. 1-5A. The attachment element 14 may take the exemplary form of a rail 14C.

In an exemplary embodiment illustrated in FIG. 5A and FIG. 5B, the attachment structures 14 may take the shape of a “rail” 14C. As shown in FIG. 5B, the second bonding surface 12 may comprise a suitably shaped recess 16 to mechanically couple with the rails 14C. In this case, the object or device comprising the second bonding surface 12 may be slotted in place through the recess 16 and the rail 14C.

It will be clear to the person skilled in the art that FIGS. 3, 4, 5A, and 5B are merely illustrations of possible attachment structures 14 that may be used. In accordance with various embodiments of the invention, any plurality of attachment structures 14 may be used that allows to mechanically couple and decouple the second bonding surface 12 to the modified gecko tape 2 essentially in (or opposite) the direction X, illustrated in e.g. FIG. 2. As mentioned above, the more attachment structures 14 and/or, more precisely, the better a force applied to the second bonding surface 12 may be distributed over the surface of the modified gecko tape 2, the better the torsion resistance. Any suitable mechanical coupling may be used for the attachment structures 14 and their counterparts as long as a mechanically relatively stable connection between the flexible, modified gecko tape 2 and the essentially non-flexible object, device or second bonding surface 12 may be achieved.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. (canceled)

2. A system for reusable high-strength adhesive mounts comprising:
a flexible modified gecko tape, wherein said gecko tape comprises a nanostructured side and a non-structured side and said non-structured side comprises a plurality of attachment structures; and
a non-flexible second bonding side comprising a plurality of attachment counterparts enabled to mechanically couple to said attachment structures;
wherein:
said mechanical coupling is operable to couple and decouple multiple times; and
said mechanical coupling of said flexible modified gecko tape with said non-flexible second bonding side creates a torsion-resistant assembly.
